(19) United States
(12) Patent Application Publication
(10) Pub. No.: US 2007/0038660 A1
(43) Pub. Date: Feb. 15, 2007

(54) Support apparatus and computer-readable storage medium

(75) Inventors: Noriyasu Nakayama, Kawasaki (JP); Yutaka Awata, Kawasaki (JP); Nobukazu Koizumi, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/281,579

(22) Filed: Nov. 18, 2005

(30) Foreign Application Priority Data
Aug. 3, 2005 (JP) 2005-225056

(51) Int. Cl. G06F 7/00

(52) U.S. Cl. 707/101

(57) ABSTRACT

A design support apparatus is provided with a first managing part to manage design documents that become input information to design processes, an extracting part to extract at least one of specification undetermined items, inspecting items of results and caution items for design, from the design documents managed by the first managing part, and a display part to display a list of items extracted by the extracting part.

### BACKGROUND OF THE INVENTION

1. Field of the Invention

The present invention generally relates to design support apparatuses and computer-readable storage media, and more particularly to a design support apparatus which manages design documents and the like related to circuits, devices and the like that are to be designed, and to a computer-readable storage medium which stores a program for causing a computer to operate as such a design support apparatus.

2. Description of the Related Art

When managing projects for designing circuits, devices and the like, the design documents and the like are managed by the design support apparatus. For example, a method of generating a reference clock that is used, transistors that are used and the like in the circuit, device or the like that is to be designed, are written in the design document.

However, contents of the design document are not all determined simultaneously. Some items are successively determined during the design stages, and some items are provisionally determined and finally determined later. For example, the items that are finally determined later include specification undetermined items within the specification of the circuit, device or the like that is to be designed, undetermined items within the minutes of the project conference, and the like. In this specification, such items that are finally determined later will be referred to items that requires some kind of determination (or action), that is, “action items”.

Conventionally, the action item is managed by a person in charge by using a spread sheet or the like, separately from the design document. In addition, check items for checking results (or performances) peculiar to an application of the circuit, device or the like that is to be designed, are also managed by the person in charge by using the spread sheet or the like, separately from the design document.

Accordingly, in the conventional design support apparatus, the management of the action items within the design document and the management of the check items for checking the results peculiar to the application are made by the person in charge, and this person in charge must maintain the completeness (or data integrity) of a management list of the managing items that need to be managed with care.

However, it is difficult to rely on the person in charge to maintain the completeness (or data integrity) of the management list of the action items, the check items for checking the results peculiar to the application, and the like that need to be managed with care, and there was a problem in that there is a possibility of introducing omissions in the management list.

The applicants are aware of Japanese Patent Applications No.9-73459, No.2002-230042, No.2004-199347 and No.2004-246504, and a U.S. Patent Application Publication No. US2004/123250A1 which corresponds to the Japanese Laid-Open Patent Application No.2004-199347.

### SUMMARY OF THE INVENTION

Accordingly, it is a general object of the present invention to provide a novel and useful design support apparatus and computer-readable storage medium, in which the problems described above are suppressed.

Another and more specific object of the present invention is to provide a design support apparatus and a computer-readable storage medium, which automatically extract items that are to be managed from a design document, so that it is possible to maintain completeness (or data integrity) of a management list without relying on a person in charge.

Still another object of the present invention is to provide a design support apparatus comprising a first managing part configured to manage design documents that become input information to design processes; an extracting part configured to extract at least one of specification undetermined items, inspecting items of results and caution items for design, from the design documents managed by the first managing part; and a display part configured to display a list of items extracted by the extracting part. According to the design support apparatus of the present invention, it is possible to automatically extract items that are to be managed from a design document, so that it is possible to maintain completeness (or data integrity) of a management list without relying on a person in charge.

A further object of the present invention is to provide a computer-readable storage medium that stores a program for causing a computer to carry out a design support, the program comprising a first managing procedure causing the program to manage design documents that become input information to design processes; an extracting procedure causing the computer to extract at least one of specification undetermined items, inspecting items of results and caution items for design, from the design documents managed by the first managing procedure; and a display procedure causing the program to display a list of items extracted by the extracting procedure. According to the computer-readable storage medium of the present invention, it is possible to automatically extract items that are to be managed from a design document, so that it is possible to maintain completeness (or data integrity) of a management list without relying on a person in charge.

Other objects and further features of the present invention will be apparent from the following detailed description when read in conjunction with the accompanying drawings.

### BRIEF DESCRIPTION OF THE DRAWINGS

FIG. 1 is a system block diagram showing a first embodiment of a design support apparatus according to the present invention;

FIG. 2 is a diagram showing a structure of a work flow;

FIG. 3 is a diagram showing a process information table;

FIG. 4 is a diagram showing a process state management table;

FIG. 5 is a diagram showing a relation information table;

FIG. 6 is a diagram showing a completion condition management table;

FIG. 7 is a diagram showing a reference information table;

FIG. 8 is a diagram showing an electronic document definition table;

FIG. 9 is a diagram showing a registration information management table;

FIG. 10 is a diagram showing a minutes management table;

FIG. 11 is a diagram showing a progress report management table;

FIG. 12 is a diagram showing an action item management table;

FIG. 13 is a diagram showing a bug management table;

FIG. 14 is a diagram showing a check list management table;

FIG. 15 is a diagram showing an example of a design document;

FIG. 16 is a diagram showing an example of a display of a list of TBD items;

FIG. 17 is a flow chart for explaining a processing procedure for displaying the list of TBD items;

FIG. 18 is a flow chart for explaining a processing procedure for displaying a list of specification undetermined items;

FIG. 19 is a flow chart for explaining another processing procedure for displaying the list of specification undetermined items;

FIG. 20 is a flow chart for explaining a processing procedure for displaying a list of items;

FIG. 21 is a flow chart for explaining a processing procedure for registering AI items;

FIG. 22 is a flow chart for explaining an item registering procedure for registering a check list; and

FIG. 23 is a flow chart for explaining a completing procedure for completing a design process.

### DESCRIPTION OF THE PREFERRED EMBODIMENTS

A description will be given of embodiments of the design support apparatus and the computer-readable storage medium according to the present invention, by referring to the drawings.

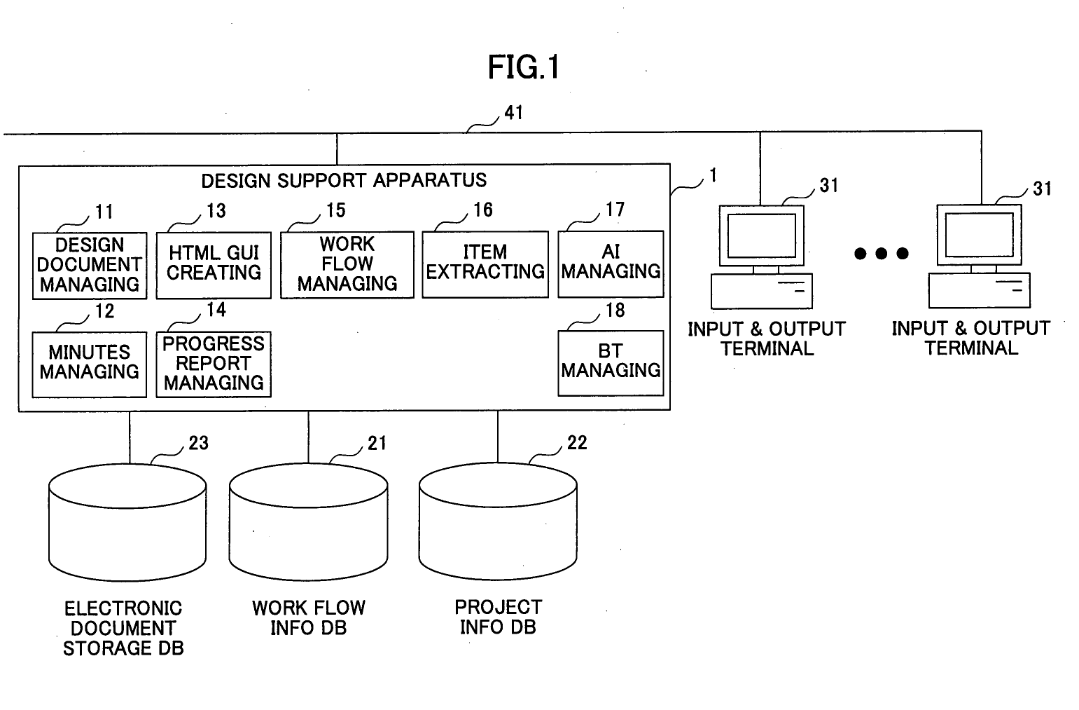

FIG. 1 is a system block diagram showing a first embodiment of the design support apparatus according to the present invention. As shown in FIG. 1, a design support apparatus 1 includes a design document managing part 11, a minutes managing part 12, an HTML GUI creating part 13, a progress report managing part 14, a work flow managing part 15, an item extracting part 16, an action item (AI) managing part 17, and a bug tracking (BT) part 18. The design support apparatus 1 is connected to a work flow information database (DB) 21, a protect information database (DB) 22, and an electronic document storage database (DB) 23. In addition, the design support apparatus 1 is provided with a known user interface that utilizes the Web, for example, and is usable from a plurality of input and output terminals 31 via a cable and/or wireless network 41 such as a LAN.

The design support apparatus 1 may be formed by a general purpose computer having a known structure including a processor such as a CPU, a storage unit such as a memory, an input part such as a keyboard, and a display part. The functions of each of the parts 11 through 18 of the design support apparatus 1 may be realized by the operations of the processor of the general purpose computer. In addition, each input and output terminal 31 may also be formed by a general purpose computer having a known structure including a processor such as a CPU, a storage unit such as a memory, an input part such as a keyboard, and a display part.

This first embodiment of the computer-readable storage medium stores a program that is executed by the processor of the general purpose computer described above, and causes the general purpose computer to operate as the design support apparatus 1. The computer-readable storage medium is formed by a recording medium which stores such a program. The computer-readable storage medium may be formed by any kind of recording media capable of storing the program in a computer-readable manner, and is not limited to a specific kind of recording media. For example, the recording medium may be selected from magnetic recording media, optical recording media, magneto-optical recording media, and semiconductor memory devices.

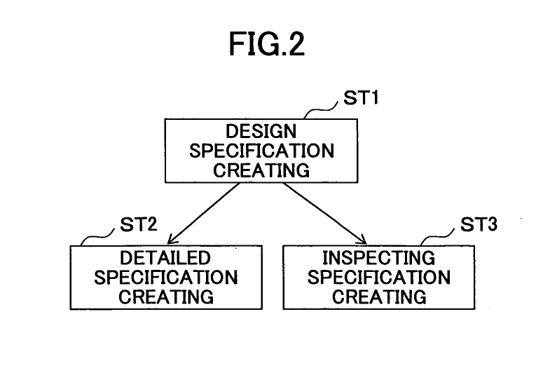

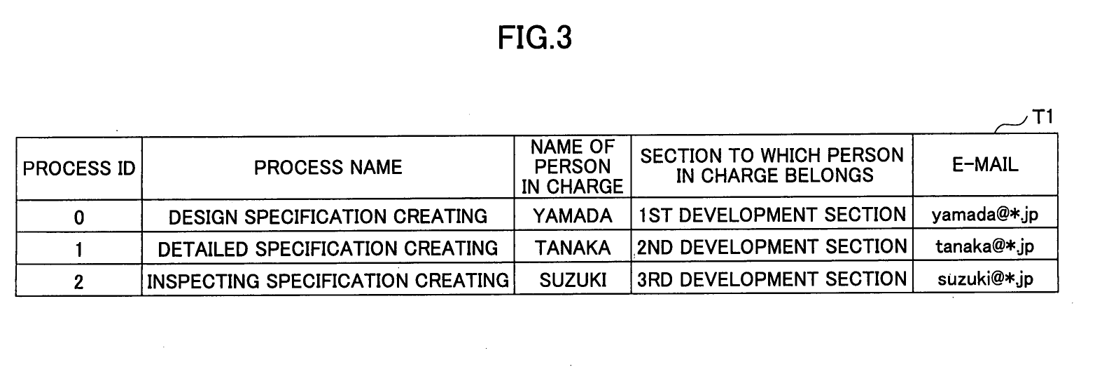

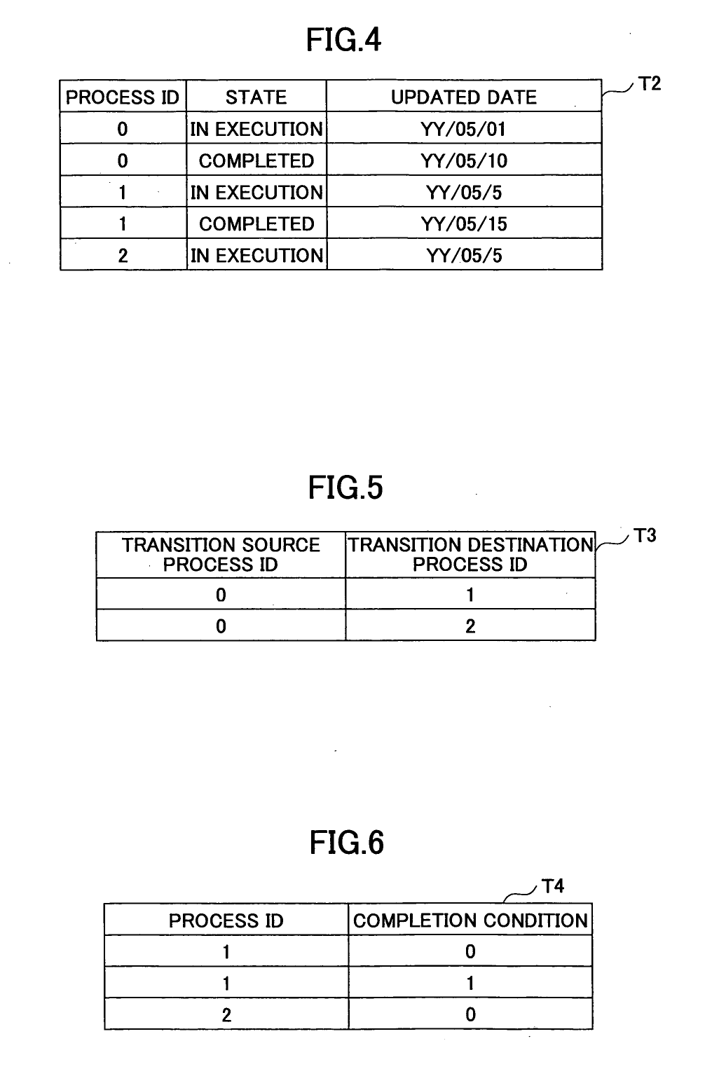

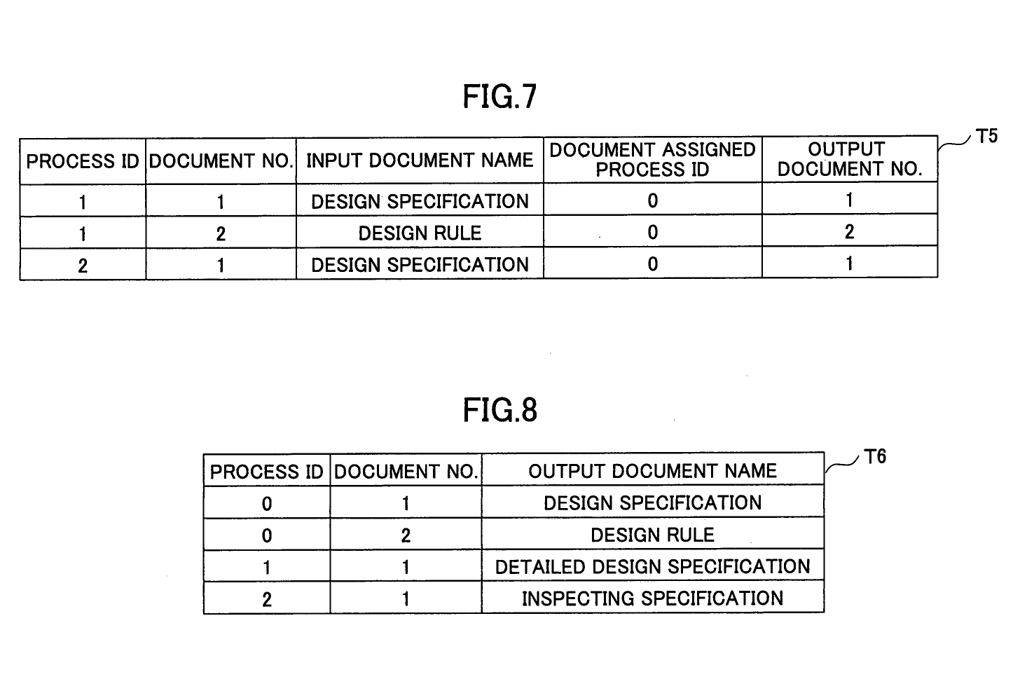

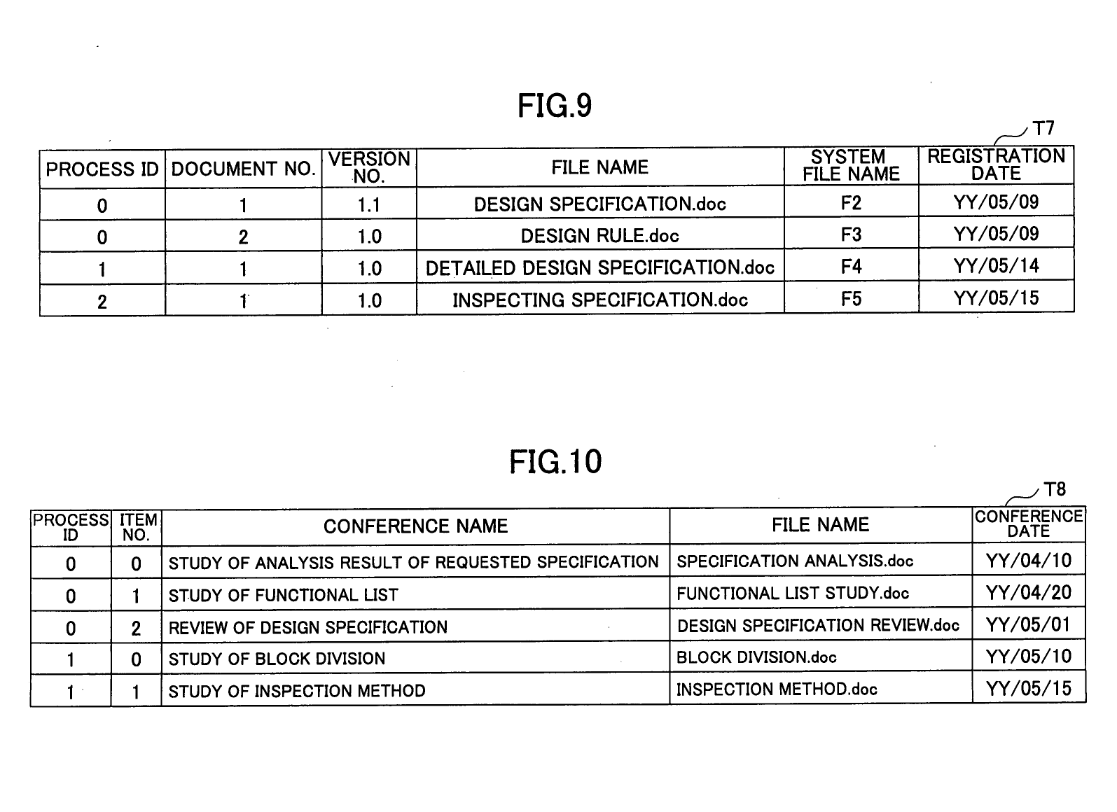

The work flow information database 21 is used to store process information forming a work flow shown in FIG. 2, for example. FIG. 2 is a diagram showing a structure of the work flow. The work flow shown in FIG. 2 includes a design specification creating process (or step) ST1 for creating a design specification, a detailed specification creating process (or step) ST2 for creating a detailed specification based on the design specification created by the design specification creating process (or step) ST1, and an inspecting specification creating process (or step) ST3 for creating an inspecting specification based on the design specification created by the design specification creating process (or step) ST1. The work flow information database 21 stores an information table T1 shown in FIG. 3, a process state management table T2 shown in FIG. 4, a relation information table T3 shown in FIG. 5, a completion condition management table T4 shown in FIG. 6, a reference information table T5 shown in FIG. 7, an electronic document definition table T6 shown in FIG. 8, and a registration information management table T7 shown in FIG. 9, under the management of the work flow managing part 15. Accordingly, it is possible to manage the information by relating the information to the structure of the work flow of the design document.

The process information table T1 stores information related to processes, such as a process name, a name person in charge, a section to which the person in charge belongs and an electronic mail (e-mail), with respect to an identification (ID) of each design process (hereinafter simply referred to as a process ID). The process state management table T2 stores information related to a state of the process and an updated date, with respect to each process ID. The relation information table T3 stores relation information of adjacent processes, that is, a transition destination process ID with respect to a transition source process ID. The completion condition management table T4 stores a completion condition at the time of the process completion, with respect to each process ID. In FIG. 6, “0” indicates that all check lists have been completed, and “1” indicates that all action items have been completed. The reference information table T5 stores reference information to the electronic document, which becomes the input information to the design process, such as a document number, an input document name, a document assigned process ID and an output document number, with respect to each process ID. The electronic document definition table T6 stores the electronic document, which becomes output information of the design process, such as a document number and an output document name, with respect to each process ID. The registration information management table T7 stores registration information of output real data, such as a document number, a version number, a file name, a system file name and a registration date, with respect to each process ID.

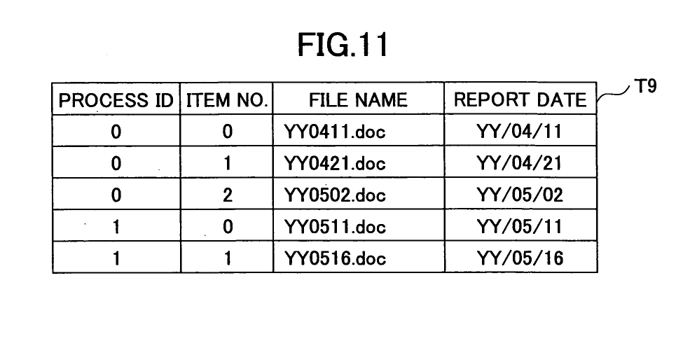

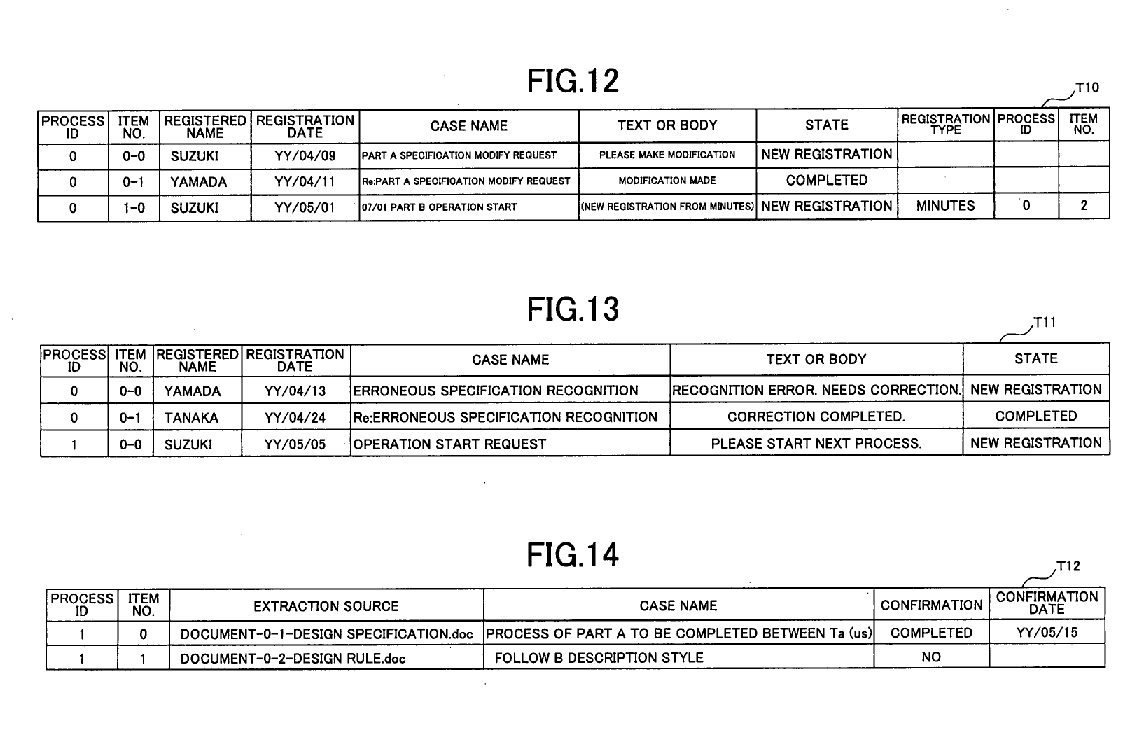

The project information database 22 stores a minutes management table T8 shown in FIG. 10, a progress report management table T9 shown in FIG. 11, an action item management table T10 shown in FIG. 12, a bug management table T11 shown in FIG. 13, and a check list management table T12 shown in FIG. 14.

The minutes management table T8 stores information of a minutes file, such as an item number, a conference name, a file name and a conference date, with respect to each process ID. The progress report management table T9 stores information related to a progress report file, such as an item number, a file name and a report date, with respect to each process ID. The action item management table T10 stores information related to the action item, such as an item number, a registered name, a registration date, a case name, a text or body, a state, a registration type, a process ID and an item number, with respect to each process ID. The bug management table T11 stores bug information (or bug report), such as an item number, a registered name, a registration date, a case name, a text or body and a state, with respect to each process ID. The check list management table T12 stores information related to precautions, such as an item number, an extraction source, a case name, a confirmation and a confirmation date, with respect to each process ID.

The electronic document storage database 23 stores electronic documents. The electronic documents such as design documents, minutes, and progress reports are input by the user from the input and output terminal 31, and stored in the electronic document storage database 23 under the management of the corresponding design document managing part 11, the minutes managing part 12 and the progress report managing part 14.

If it is assumed for the sake of convenience that the design documents having the output document names stored in the electronic document definition table T6 shown in FIG. 8 are registered in the registration information management table T7 as shown in FIG. 9, these design documents become search targets.

The item extracting part 16 searches within the design document that is the search target, using keywords, and extracts desired items. For example, the keywords may be “TBD (To Be Determined)” for extracting the specification undetermined item, “Check” indicating the check item of the result peculiar to the application, and “Caution” indicating the caution item for the design.

Each of these keywords must be a character string that does not appear within the normal design document. In this embodiment, a line (or row) having such a keyword at the beginning becomes the extracting target.

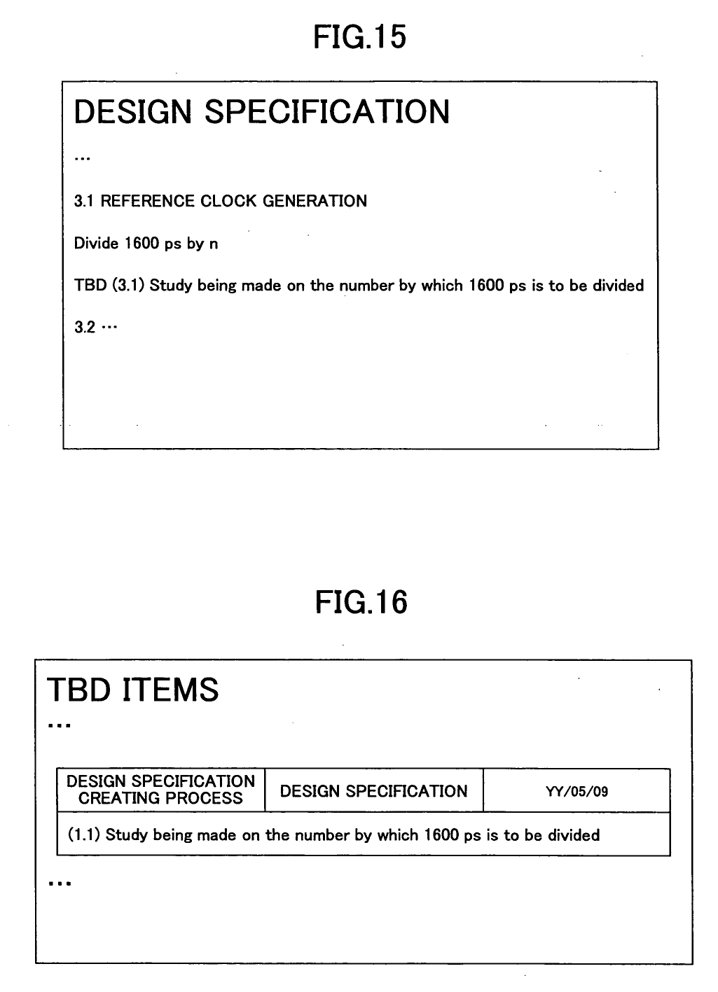

FIG. 15 is a diagram showing an example of the design document. It is assumed for the sake of convenience that the design document shown in FIG. 15 is the “Design Specification.doc” shown in FIG. 9, for example. In this case, the line “TBD (3.1) Study being made on the number by which 1600 ps is to be divided” is extracted by the item extracting part 16 as the specification undetermined item.

Since the process ID to which this design document belongs is “0” from the registration information management table T7 shown in FIG. 9, it may be found that from the process information table T1 shown in FIG. 3 that this design document is the result of the design process having the process name “design specification creation”. If it is necessary to know the state of the design process, a reference may be made to the process state management table T2 shown in FIG. 2.

In addition, it may be found from the registration information management table T7 shown in FIG. 9 that the final updated date of this design document is “YY/05/09” indicating May 5 of the year YY (or 20YY).

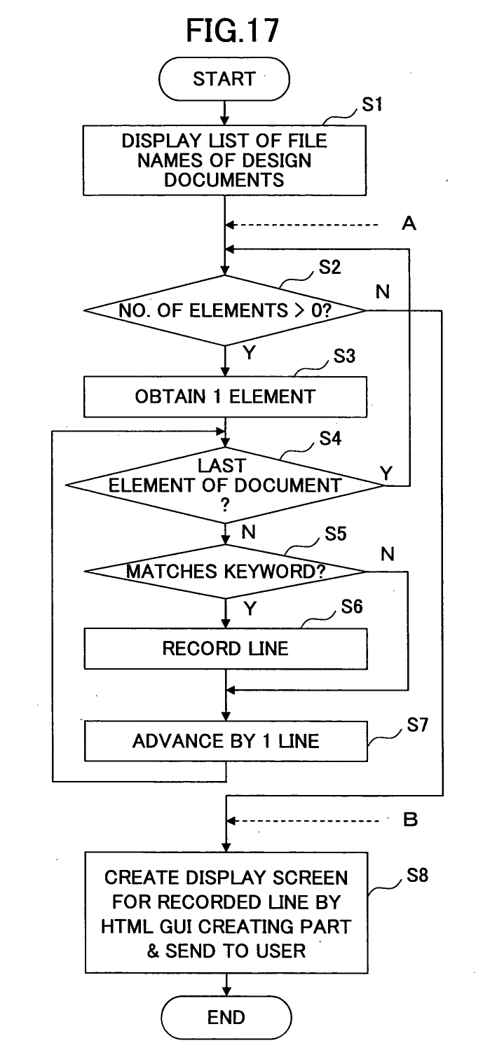

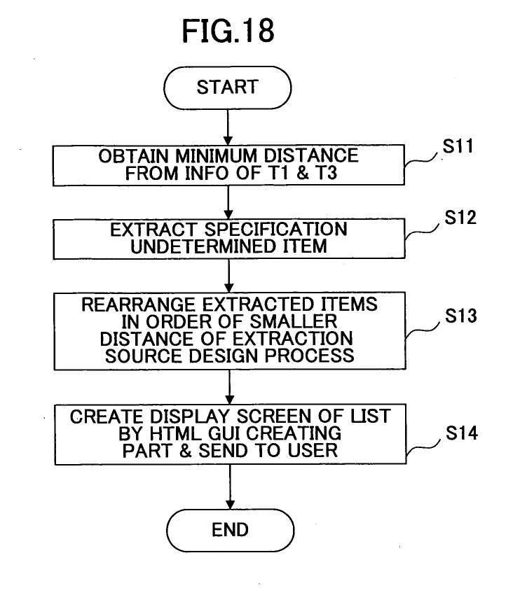

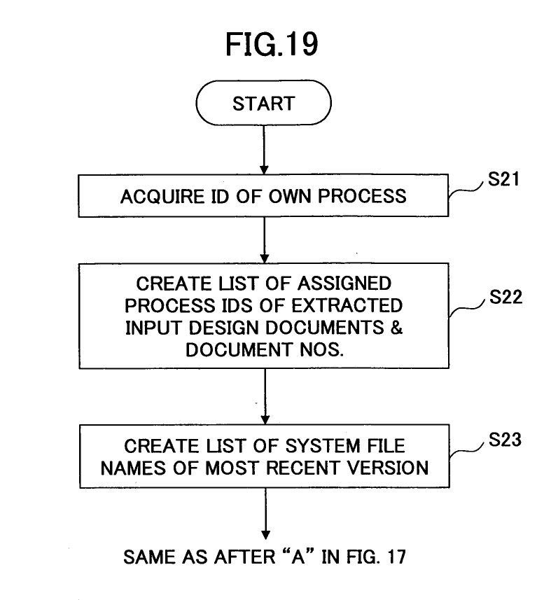

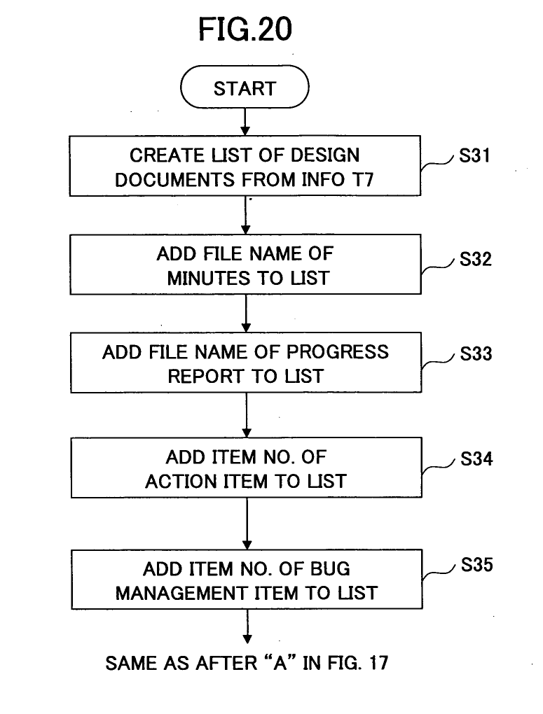

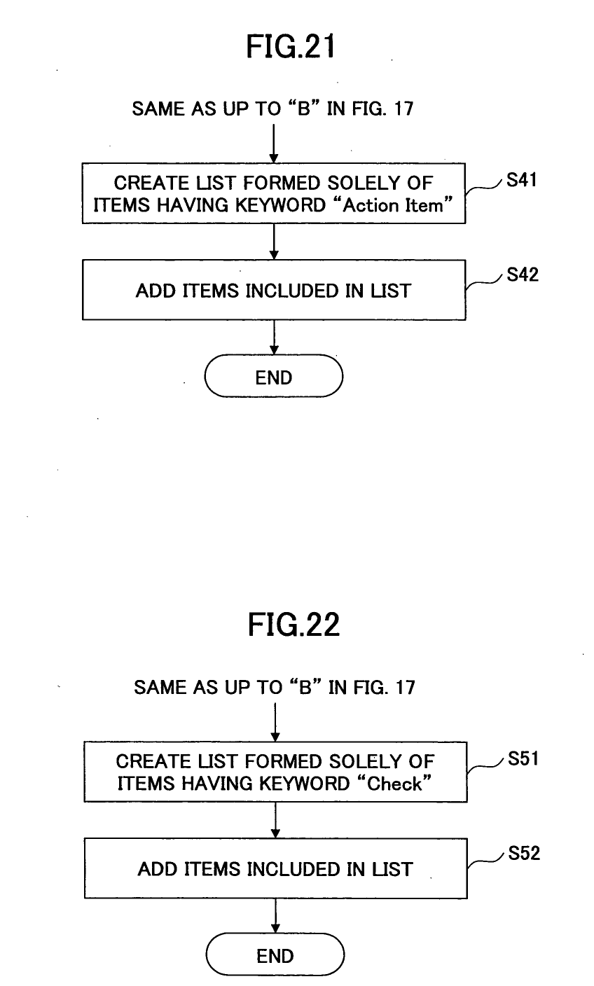

Based on the above information, the HTML GUI creating part 13 creates a list of TBD items shown in FIG. 16, and displays this list of TBD items on the display part of the input and output terminal 31 of the user. FIG. 17 is a flow chart for explaining a processing procedure of the design support apparatus 1, that is, the processing procedure executed by the processor of the general purpose computer, for displaying the list of TBD items.

In FIG. 17, a step S1 displays a list of the file names of the design documents stored in the registration information management table T7 shown in FIG. 9 on the display part of the input and output terminal 31 of the user. In this case, if a plurality of design documents (files) having the same process ID or the same document number exist, only the most recent version of the design document is included in the list. A step S2 decides whether or not a number of elements such as words included in the design document that is selected from the list by an operation made by the user from the input part of the input and output terminal 31 is greater than 0. If the decision result in the step S2 is NO, the process advances to a step S8 which will be described later.

If the decision result in the step S2 is YES, a step S3 obtains 1 element from 1 line of the design document. A step S4 decides whether or not the element obtained from the design document is the last element. The process returns to the step S2 if the decision result in the step S4 is YES. If the decision result in the step S4 is NO, a step S5 decides, by the item extracting part 16, whether or not the obtained element matches the keyword that is set by the user from the input part of the input and output terminal 31. If the decision result in the step S5 is YES, the TBD item is extracted, and a step S6 records the line that includes the element matching the keyword. After the step S6 or, if the decision result in the step S5 is NO, a step S7 advances the line from which the element is to be obtained by 1 line, and the process returns to the step S4.

The step S8 creates a display screen including a list of the extracted TBD items as shown in FIG. 16, by the HTML GUI creating part 13, with respect to the recorded line, and sends the created display screen to the input and output terminal 31 of the user to be displayed on the display part thereof, and the process ends.

Next, a description will be given of a second embodiment of the design support apparatus according to the present invention. This second embodiment of the design support apparatus and third through sixth embodiments of the design support apparatus which will be described later respectively have the same structure as the first embodiment shown in FIG. 1, and an illustration and description thereof will be omitted. In addition, second through sixth embodiments of the computer-readable storage medium according to the present invention store programs that cause the general purpose computer to operate as the corresponding second through sixth embodiments of the design support apparatus.

For the sake of convenience, a description will be given of this second embodiment by taking the example of the work flow shown in FIG. 2. A minimum distance from the most significant design process having the process ID “0” to each of the design processes on the work flow may be obtained from the information of the process information table T1 shown in FIG. 3 and the relation information table T3 shown in FIG. 5. For example, the distance from the design process having the process ID “0” to the design process having the process ID “1” may be calculated within the work flow managing part 15, for example, by regarding the difference between the values of the process IDs to be “1”. If the design process having the process ID “0” and the design process having the process ID “1” include the specification undetermined item and the list of the specification undetermined items is to be displayed in an order starting from the design process having the smallest distance, the list of the specification undetermined items can be displayed in an order corresponding to the order of the design processes having the smaller distance, namely, the process ID “0”, the process ID “1”, . . . since the distance of the process ID “0” to the process ID “0” is “0”. FIG. 18 is a flow chart for explaining a processing procedure of the design support apparatus 1, that is, the processing procedure executed by the processor of the general purpose computer, for displaying the list of specification undetermined items.

In FIG. 18, the minimum distance from the design process having the process ID “0” to each of the design processes is obtained from the information stored in the process information table T1 shown in FIG. 3 and the relation information table T3 shown in FIG. 5. In this case, it is assumed for the sake of convenience that the distance of all links is “1”. A step S12 extracts the specification undetermined items by the item extracting part 16, with respect to the design documents stored in the registration information management table T7 shown in FIG. 9 by regarding these design documents as targets. A step S13 rearranges the extracted specification undetermined items in the order of the extracted source design processes having the smaller distance and obtained in the step S11. A step S14 creates a display screen including the list of the specification undetermined items that are rearranged in the order of the extracted source design processes having the smaller distance, by the HTML GUI creating part 13, and sends this display screen to the input and output terminal 31 of the user to be displayed on the display part thereof. The process ends after the step S14. It is also possible to group the specification undetermined items in categories depending on the size of the distance on the work flow described above.

Next, a description will be given of the third embodiment of the design support apparatus according to the present invention. In this case, it is assumed for the sake of convenience that the operation of the detailed specification creating process ST2 is carried out in the work flow shown in FIG. 2. For the person in charge of this detailed specification creating process ST2, the design documents circulated from the design specification creating process ST1 which is on the upstream side of the detailed specification creating process ST2 are important, but the results of the inspecting specification creating process ST3 are not directly related to the detailed specification creating process ST2 in this case. It may be found from the information of the process information table T1 shown in FIG. 3 that the process ID of the detailed specification creating process ST2 is “1”, and it may be found from the reference information table T5 shown in FIG. 7 that the design documents referred to from the detailed specification creating process ST2 are the 2 design documents “design specification” and “design rule” having the process ID “0”. Hence, it is possible to similarly extract the specification undetermined items by the item extracting part 16 by limiting the targets to these 2 design documents, and to display a list of the extracted specification undetermined items. FIG. 19 is a flow chart for explaining another processing procedure of the design support apparatus 1, that is, the processing procedure executed by the processor of the general purpose computer, for displaying the list of specification undetermined items.

In FIG. 19, a step S21 acquires the process ID of the own design process from the information stored in the process information table T1 shown in FIG. 3. A step S22 extracts items having the own process ID by the item extracting part 16, from on the information stored in the reference information table T5 shown in FIG. 7, and creates a list of the document assigned process ID and the document number of the extracted input design documents. A step S23 creates a list of the system file names of the most recent version, of the design documents corresponding to the process ID and the document number included in the list, from the information stored in the registration information management table T7 shown in FIG. 9. Steps similar to the step S2 and the subsequent steps shown in FIG. 17 are carried out after the step S23.

Next a description will be given of the fourth embodiment of the design support apparatus according to the present invention. The minutes information and the process report information are respectively stored in the minutes management table T8 shown in FIG. 10 and the progress report management table T9 shown in FIG. 11, under the management of the corresponding minutes managing part 12 and the progress report managing part 14. The contents of the minutes management table T8 and the progress report management table T9 exist as files within the electronic document storage database 23. The action item information and the bug information are respectively stored in the action item management table T10 shown in FIG. 12 and the bug management table T11 shown in FIG. 13, under the management of the corresponding AI managing part 17 and the BT managing part 18. The contents of the action item management table T10 and the bug management table T11 are included in the “text (or body)” field of the electronic document storage database 23. The minutes information, the progress report information, the action item information and the bug information may be referred to from the item extracting part 16, and the items may be similarly extracted and displayed. FIG. 20 is a flow chart for explaining a processing procedure of the design support apparatus 1, that is, the processing procedure executed by the processor of the general purpose computer, for displaying a list of such items.

In FIG. 20, a step S31 creates a list of design documents from the information stored in the registration information management table T7 shown in FIG. 9. In this case, if a plurality of design documents (files) having the same process ID or the same document number exist, only the most recent version of the design document is included in the list. A step S32 extracts the file name of the minutes from the information stored in the minutes management table T8 shown in FIG. 10, by the item extracting part 16, and adds the extracted file name of the minutes to the list described above. A step S33 extracts the file name of the progress report from the information stored in the progress report management table T9 shown in FIG. 11, by the item extracting part 16, and adds the extracted file name of the progress report to the list described above. A step S34 extracts the item number of the action item from the information stored in the action item management table T10 shown in FIG. 12, by the item extracting part 16, and adds the extracted item number of the action item to the list described above. A step S35 extracts the item number of the bug management item from the information stored in the bug management table T11 shown in FIG. 13, by the item extracting part 16, and adds the extracted item number of the bug management item to the list described above. Steps similar to the step S2 and the subsequent steps shown in FIG. 17 are carried out after the step S35.

Next, a description will be given of the fifth embodiment of the design support apparatus according to the present invention. The action item may have an exclusive keyword, so that the action item is distinguishable from other extracted items. For example, suppose that the keyword for the action item is “Action Item”. The item that is extracted by this keyword “Action Item” is supplied to the AI managing part 17 shown in FIG. 1. The AI managing part 17 has an action item managing function for managing the coping with respect to each registered item until completion of the coping, including intermediate exchanges between the persons in charge, as in the case of the action item management table T10 shown in FIG. 12. For example, in a case where the minutes include a description “Action Item 07/01 Operation Started by Section B”, the action item having the extracted item as the case name is registered, as in the case of the third process in the action item management table T10 shown in FIG. 12. FIG. 21 is a flow chart for explaining a processing procedure of the design support apparatus 1, that is, the processing procedure executed by the processor of the general purpose computer, for registering the action items.

Steps similar to the steps up to the step S7 shown in FIG. 17 are carried out prior to a step S41 shown in FIG. 21. The step S41 creates a list formed solely by the items having the keyword “Action Item”. A step S42 adds the items included in the above list to the action item management table T10 shown in FIG. 12, and the process ends. In this case, the process ID is the document assigned process ID of the design document from which the above applicable items are extracted, the item number is a serial number, the state is “new registration”, and others are blank.

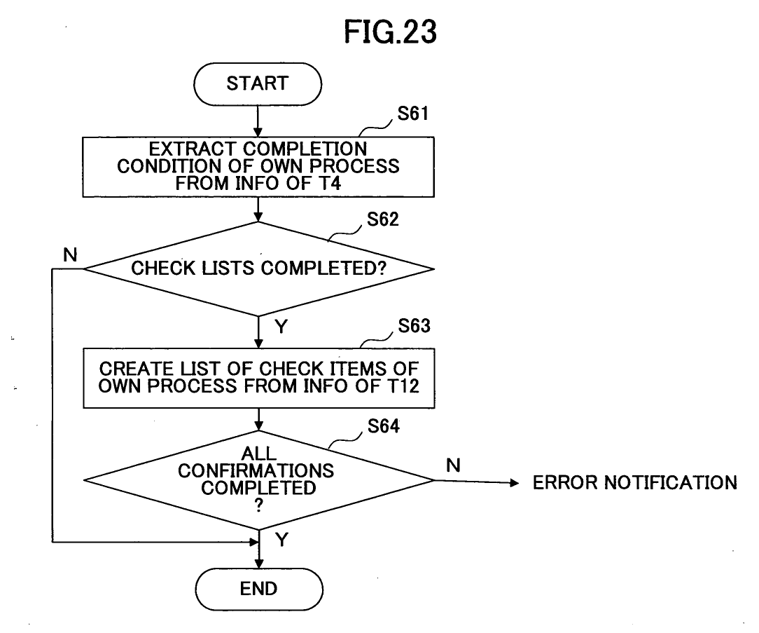

Next, a description will be given of a sixth embodiment of the design support apparatus according to the present invention. The item related to the inspecting item of the result may have an exclusive keyword, such as “Check”, so that this item is distinguishable from other extracted items. The extracted items are managed by the project information database 22, as in the case of the check list management table T12 shown in FIG. 14. The lists managed by the project information database 22 will be referred to as the check lists. It is possible to set a condition that the design process cannot be completed unless all of the check lists are “completed” in the condition setting at the time of the process completion of the completion condition management table T4 shown in FIG. 6. FIG. 22 is a flow chart for explaining an item registering procedure of the design support apparatus 1, that is, the processing procedure executed by the processor of the general purpose computer, for registering the check list. In addition, FIG. 23 is a flow chart for explaining a completing procedure of the design support apparatus 1, that is, the processing procedure executed by the processor of the general purpose computer, for completing the design process.

Steps similar to the steps up to the step S7 shown in FIG. 17 are carried out prior to a step S51 shown in FIG. 22. The step S51 creates a list formed solely by the items having the keyword “Check”. A step S52 adds the items included in the above list to the check list management table T12 shown in FIG. 14, and the process ends. In this case, the process ID is the document assigned process ID of the design document from which the above applicable items are extracted, the item number is a serial number, the extraction source is the document name of the design document from which the item is extracted, the case name is the extracted line, the confirmation is “NO”, and the confirmation date is blank.

In FIG. 23, a step S61 extracts the completion condition of the own process from the information stored in the completion condition management table T4 shown in FIG. 6. A step S62 decides whether or not the extracted completion condition includes “0” indicating that all of the check lists are completed. The process ends if the decision result in the step S62 is NO. On the other hand, if the decision result in the step S62 is YES, a step S63 creates a list of the check items of the own process, from the information stored in the check list management table T12 shown in FIG. 14. A step S64 decides whether or not the confirmation of all of the check items is completed. An error notification is made to the input and output terminal 31 of the user if the decision result in the step S64 is NO. The process ends if the decision result in the step S64 is YES.

In each of the embodiments described above, the various kinds of information displayed on the display part of the input and output terminal 31 may of course be displayed on the display part of the design support apparatus 1. In addition, the design support apparatus 1 may be designed as a stand-alone type that is also used as the input and output terminal 31.

The present invention is extremely useful in preventing omissions in the management of the design documents, because the extraction of the items such as the action items written within the design documents, the creation of the various kinds of management lists and the display of the various kinds of lists are carried out automatically.

In addition, it is possible to display the items having small distances with priority, by utilizing the work flow information and calculating the distance between the most significant process and the locations where the items are generated. Hence, from the practical point of view, the present invention is extremely useful in that the items that are considered to have large effects on the subsequent design processes can be displayed with priority.

This application claims the benefit of a Japanese Patent Application No.2005-225056 filed Aug. 3, 2005, in the Japanese Patent Office, the disclosure of which is hereby incorporated by reference.

Further, the present invention is not limited to these embodiments, but various variations and modifications may be made without departing from the scope of the present invention.

What is claimed is:

1. A design support apparatus comprising:
a first managing part configured to manage design documents that become input information to design processes;
an extracting part configured to extract at least one of specification undetermined items, inspecting items of results and caution items for design, from the design documents managed by the first managing part; and
a display part configured to display a list of items extracted by the extracting part.

2. The design support apparatus as claimed in claim 1, comprising:
a part configured to manage the design documents by relating the design documents to a work flow structure; and
a calculating part configured to calculate a distance, on the work flow, between a most significant process and design processes that sources of the items extracted by the extracting part and include the results,
wherein the display part displays the list of the extracted items after rearranging an order of the extracted items depending on a size of the distance or, after grouping the extracted items in categories depending on the size of the distance.

3. The design support apparatus as claimed in claim 1, wherein, in a downstream side design process having design documents circulated from an upstream side design process on the work flow as input information, the extracting part regards only the design documents circulated to the downstream side design process as targets from which the items are to be extracted.

4. The design support apparatus as claimed in claim 1, comprising:
a second managing part configured to manage project information including at least one of minutes, progress reports, action items and bug reports, separately from management of the design documents,
wherein the extracting part includes the project information in the items that are extracting targets to be extracted.

5. The design support apparatus as claimed in claim 1, comprising:
a part configured to add action items, of the items extracted by the extracting part, to an action item managing function.

6. The design support apparatus as claimed in claim 1, comprising:
a part configured to create check lists from items related to the inspecting items of the results, and to prohibit completion of design process and project until checking of all of the items is completed.

7. A computer-readable storage medium that stores a program for causing a computer to carry out a design support, said program comprising:
a first managing procedure causing the program to manage design documents that become input information to design processes;
an extracting procedure causing the computer to extract at least one of specification undetermined items, inspecting items of results and caution items for design, from the design documents managed by the first managing procedure; and
a display procedure causing the program to display a list of items extracted by the extracting procedure.

8. The computer-readable storage medium as claimed in claim 7, wherein said program comprises:
a procedure causing the computer to manage the design documents by relating the design documents to a work flow structure; and
a calculating procedure causing the computer to calculate a distance, on the work flow, between a most significant process and design processes that sources of the items extracted by the extracting procedure and include the results,
wherein the display procedure causes the computer to display the list of the extracted items after rearranging an order of the extracted items depending on a size of the distance or, after grouping the extracted items in categories depending on the size of the distance.

9. The computer-readable storage medium as claimed in claim 7, wherein, in a downstream side design process having design documents circulated from an upstream side design process on the work flow as input information, the extracting procedure causes the computer to regard only the design documents circulated to the downstream side design process as targets from which the items are to be extracted.

10. The computer-readable storage medium as claimed in claim 7, wherein the program comprises:
a second managing procedure causing the computer to manage project information including at least one of minutes, progress reports, action items and bug reports, separately from management of the design documents,
wherein the extracting procedure causes the computer to include the project information in the items that are extracting targets to be extracted.

11. The computer-readable storage medium as claimed in claim 7, wherein the program comprises:
a procedure causing the computer to add action items, of the items extracted by the extracting procedure, to an action item managing function.

12. The computer-readable storage medium as claimed in claim 7, wherein the program comprises:
a procedure causing the computer to create check lists from items related to the inspecting items of the results, and to prohibit completion of design process and project until checking of all of the items is completed.
